(19) United States
(12) Patent Application Publication
(10) Pub. No.: US 2015/0078404 A1
(43) Pub. Date: Mar. 19, 2015

(54) System, Method and Apparatus for Time-Sensitive Energy Efficient Networks

(71) Applicant: Broadcom Corporation, Irvine, CA (US)

(72) Inventors: Wael William Diab, San Francisco, CA (US); Mehmet Vakif Tazebay, Irvine, CA (US)

(21) Appl. No.: 14/482,009

(22) Filed: Sep. 10, 2014

Related U.S. Application Data
(60) Provisional application No. 61/876,716, filed on Sep. 11, 2013.

(51) Int. Cl. H04J 3/06; H04L 12/12

(52) U.S. Cl. CPC H04J 3/0658; H04L 12/12
USPC 370/503

(57) ABSTRACT

System, method and apparatus for time-sensitive energy efficient networks. When a network device transitions from an active mode to a low power idle (LPI) mode, refresh signaling periods can be used to communicate time synchronization information between link partners. The passage of time synchronization information in a non-packet form enables the link partner to perform an action associated with a time-sensitive network application upon transitioning of the link partner from the low power idle mode to the active mode.

This application claims the benefit of and priority to provisional application No. 61/876,716, filed Sep. 11, 2013, which is incorporated herein by reference in its entirety.

### BACKGROUND

1. Field

The present disclosure relates generally to energy efficiency and, more particularly, to a system, method and apparatus for time-sensitive energy efficient networks.

1. Introduction

Energy costs continue to escalate in a trend that has accelerated in recent years. Such being the case, various industries have become increasingly sensitive to the impact of those rising costs. One area that has drawn increasing scrutiny is the IT infrastructure. Many companies are now looking at their IT systems' power usage to determine whether the energy costs can be reduced. For this reason, an industry focus on energy-efficient networks (IEEE 802.3az) has arisen to address the rising costs of IT equipment usage as a whole (i.e., PCs, displays, printers, switches, servers, network equipment, etc.).

### BRIEF DESCRIPTION OF THE DRAWINGS

In order to describe the manner in which the above-recited and other advantages and features can be obtained, a more particular description will be rendered by reference to specific embodiments thereof which are illustrated in the appended drawings. Understanding that these drawings depict only typical embodiments and are not therefore to be considered limiting of its scope, the disclosure describes and explains with additional specificity and detail through the use of the accompanying drawings in which:

FIG. 1 illustrates an example of network link between link partners.

FIG. 2 illustrates coded refresh signals during a low power idle mode.

FIG. 3 illustrates an example of a network link between link partners that enables communication during a quiet state.

FIG. 4 illustrates a flowchart of an example process.

### DETAILED DESCRIPTION

Various embodiments are discussed in detail below. While specific implementations are discussed, it should be understood that this is done for illustration purposes only. A person skilled in the relevant art will recognize that other components and configurations may be used without parting from the spirit and scope of the present disclosure.

Ethernet has become an increasingly pervasive technology that has been applied in various contexts. The inherent simplicity of Ethernet has enabled application of the technology to various mediums, various speeds, and various distances. These features have enabled Ethernet to become a viable technology option that spans high-speed laboratory networks, commercial networks, and increasingly to consumer networks. The pervasiveness of Ethernet and other networking technologies has lead to an increased focus on energy efficiency. Various challenges in producing energy savings exist.

In one embodiment, at least part of a network device (e.g., physical layer device) can be configured to transition from an active mode to a low power idle (LPI) mode. The LPI mode can be characterized by a plurality of quiet periods where no transmission by the network device occurs and by a plurality of refresh signaling periods that enable the network device to maintain synchronization with a link partner device. While in the LPI mode, the network device can be further configured to transmit, during at least one of the refresh signaling periods, time synchronization information that enables the link partner device to perform an action associated with a time-sensitive network application upon transitioning of the link partner device from the low power idle mode to the active mode.

In various embodiments, the time synchronization information can include a timestamp, master clock priority information, or any other information that enables the link partner device to maintain time synchronization with a master clock. The maintaining of time synchronization by the link partner device enables the performance of an action associated with the IEEE 1588 protocol, the 802.1AS protocol, or any other time-sensitive protocol.

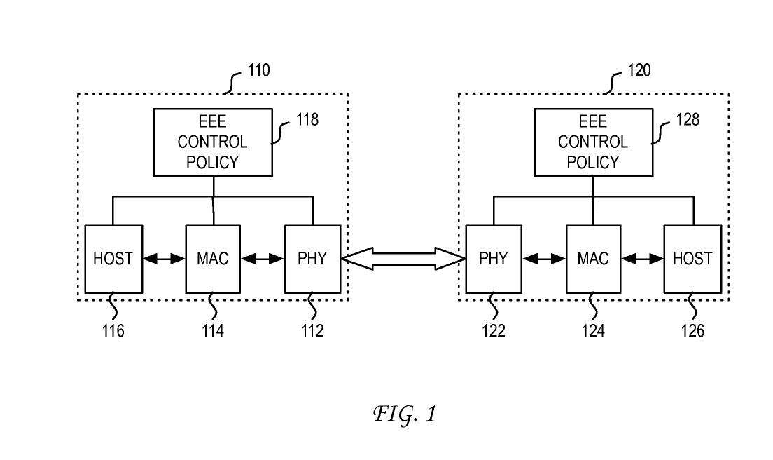

Prior to describing the passage of time synchronization information during an energy saving mode, reference is made first to FIG. 1, which illustrates an example network link to which an energy efficiency control policy of the present disclosure can be applied. As illustrated, the example link supports communication between a first link partner 110 and a second link partner 120. In various embodiments, link partners 110 and 120 can represent a switch, router, endpoint (e.g., server, client, VOIP phone, wireless access point, etc.), or any other network device. As illustrated, link partner 110 includes physical layer device (PHY) 112, media access control (MAC) 114, and host 116, while link partner 120 includes PHY 122, MAC 124, and host 126.

In general, hosts 116 and 126 may comprise suitable logic, circuitry, and/or code that may enable operability and/or functionality of the five highest functional layers for data packets that are to be transmitted over the link. Since each layer in the OSI model provides a service to the immediately higher interfacing layer, MAC controllers 114 and 124 may provide the necessary services to hosts 116 and 126 to ensure that packets are suitably formatted and communicated to PHYs 112 and 122, respectively. MAC controllers 114 and 124 may comprise suitable logic, circuitry, and/or code that may enable handling of data link layer (Layer 2) operability and/or functionality. MAC controllers 114 and 124 can be configured to implement Ethernet protocols, such as those based on the IEEE 802.3 standard, for example. PHYs 112 and 122 can be configured to handle physical layer requirements, which include, but are not limited to, packetization, data transfer and serialization/deserialization (SERDES).

As FIG. 1 further illustrates, link partners 110 and 120 also include energy efficiency control policy entities 118 and 128, respectively. In general, energy efficiency control policy entities 118 and 128 can be designed to determine when to enter an energy saving mode, what energy saving mode (i.e., level of energy savings) to enter, how long to remain in that energy saving mode, what energy saving mode to transition to out of the previous energy saving mode, etc.

In general, energy efficiency control policy entities 118 and 128 can comprise suitable logic, circuitry, and/or code that may be enabled to establish and/or implement an energy efficiency control policy for the network device. In various embodiments, energy efficiency control policy entities 118 and 128 can be a logical and/or functional block which may, for example, be implemented in one or more layers, including portions of the PHY or enhanced PHY, MAC, switch, controller, or other subsystems in the host, thereby enabling energy-efficiency control at one or more layers.

In general, controlling the data rate of the link may enable link partners 110 and 120 to communicate in a more energy-efficient manner. More specifically, a reduction in link rate to a sub-rate of the main rate enables a reduction in power, thereby leading to energy savings. In one example, this sub-rate can be a zero rate, which produces maximum power savings. One example of subrating is through the use of a low power idle (LPI) technique. In general, LPI relies on turning the active channel silent when there is nothing to transmit. Energy is thereby saved when the link is off.

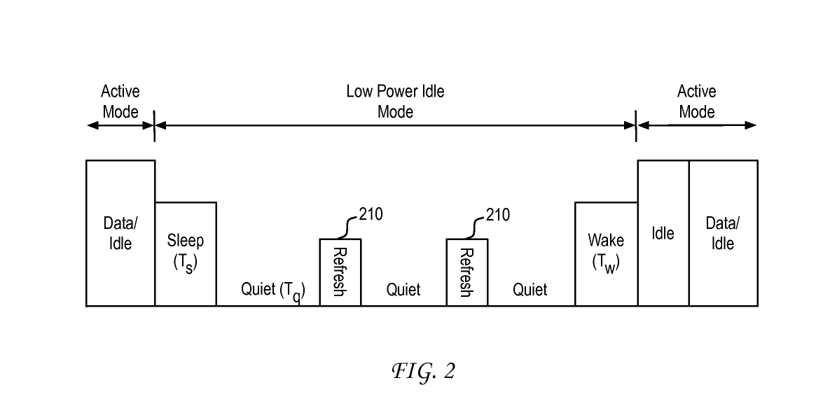

FIG. 2 illustrates the transitions between an active mode and an LPI mode. As illustrated, a transmitter can begin in an active mode where data traffic and normal idle signals are transmitted. When it is determined by an energy efficiency control policy that the absence of data traffic indicates a sufficiently low link utilization condition, the energy efficiency control policy can then instruct the transmitter to enter into a LPI mode. A transition from an active mode to the LPI mode takes a sleep time Tₛ, after which time the transmitter can enter a quiet state. The transmitter can also signal the receiver to enter into a sleep state. The transmitter can stay quiet for a time T_{q}, after which time the transmitter will transmit a refresh signal during refresh signaling period 210.

In general, refresh signals are sent periodically to keep the link alive and to enable the receiver to maintain synchronization (e.g., frequency/phase lock) and filter/equalization adaptation. This enables the transmitter and receiver in the link partners to minimize the amount of time that it takes to transition from the LPI mode back to an active mode for the continued exchange of data traffic.

As the transmitter and receiver can remain in the quiet state until data traffic is ready to be transmitted, significant energy savings can be achieved. When there is data to transmit, a wake signal (e.g., normal idle signal) can be used to wake the transmitter and receiver up before the data traffic can be sent. In this wakeup process, a time period T_{w} would be used to wake up and re-enter the active mode once again for transmission of data traffic that is available.

One area of application for energy-efficiency initiatives is industrial, automotive, automation, transportation, and control networks. One of the challenges of applying energy-efficiency initiatives to industrial, automotive, automation, transportation, and control networks is the impact on time-sensitive network protocols. As noted above, the usage of energy saving modes such as the LPI mode can produce energy savings, but can compromise the ability of the link partners to maintain time synchronization for IEEE 1588 protocols, IEEE 802.1AS protocols, or any other time-sensitive network protocol.

It is therefore recognized that a complementary mechanism is needed such that time-sensitive network operation (e.g., actuators, sensors, or other time-sensitive element) is insensitive to the energy efficiency operation of the network. It is a feature of the present disclosure that an energy saving mode (e.g., LPI mode) can be used in a manner that is transparent to the operation of time-sensitive network protocols. This feature of the present disclosure can be enabled through the use of intelligent communication during the energy saving mode.

As noted above, energy efficiency networks can be based on an energy efficiency control policy that establishes a period of lower activity (e.g., no data transmission during the LPI mode) where the transmitting and receiving link partner are in a sleep state. The usage of these sleep states for prolonged periods can disrupt the ability of the link partners to maintain time synchronization and can therefore negatively impact the ability of the link partners to perform immediate time-sensitive protocol actions upon wake-up from the sleep state. In the present disclosure it is recognized that a mechanism that complements an energy efficiency network is desired that would not disrupt, or virtually not disrupt command/control communication.

In one embodiment, communication during the energy saving mode (e.g., LPI mode) can be used to enable actions taken by the link partners upon transitioning from the energy saving mode back to the active mode. Performance of the link partners after transitioning from the energy saving mode back to the active mode would therefore not be compromised.

To illustrate these concepts, consider the example of the LPI mode illustrated in FIG. 2. During the LPI mode, a link partner would interrupt a quiet state to transmit a refresh signal, then return back to the quiet state to produce energy savings. In the present disclosure, the refresh signal time period 210 can be used to pass time synchronization information such as a timing label, time stamp, synchronization signal, master clock priority information, or any other information used by a time-sensitive network protocol to establish time synchronization.

As would be appreciated, the signaling of time synchronization information during the refresh signaling time period 210 would be less than a minimum packet size and can be decoded faster as compared to a packet. In general, the receipt of the time synchronization information during the refresh signaling time period would assist the link partner in performing time-sensitive network protocol actions upon transitioning from the energy saving mode back to the active mode. In one embodiment, the time synchronization information can be used to modify time-sensitive protocol parameters.

In one embodiment, the communication scheme can be superimposed on legacy energy efficient interfaces by adjusting the sequence of physical signaling that is used during one or more of the refresh signaling time periods. On new interfaces that have yet to be standardized, a new physical signaling scheme can be defined for one or more of the refresh signaling time periods to meet the needs of a particular implementation.

As would be appreciated, the principles of the present disclosure are not limited to particular examples of signaling during one or more of the refresh signaling time periods. In general, any form of communication of information during one or more of the refresh signaling time periods can be used such that time-sensitive protocol actions that are performed upon wake-up from the quiet state are assisted, modified, eliminated, or otherwise impacted.

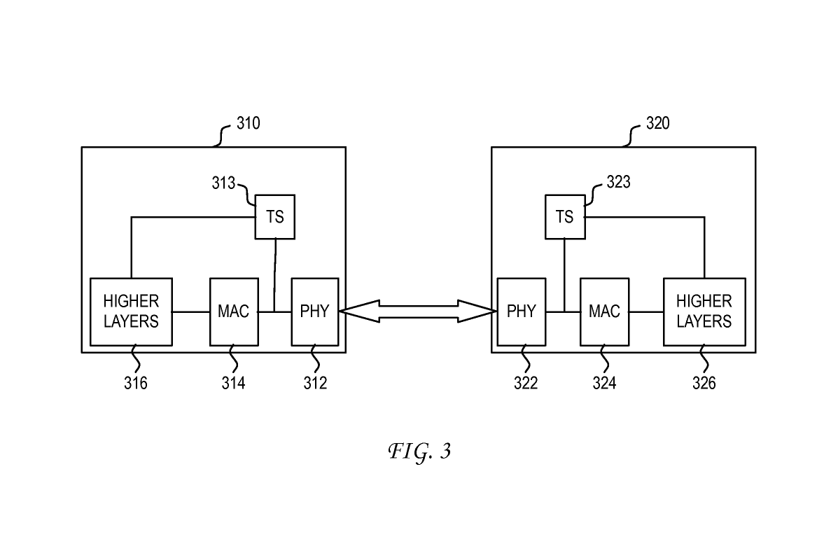

FIG. 3 illustrates an example of a network link that enables communication during the energy saving mode. As illustrated, link partner 310 includes PHY 312, MAC 314, and higher layers 316, while link partner 320 includes PHY 322, MAC 324, and higher layers 326. PHYs 312, 322 and MACs 314, 324 can include functionality similar to that described with respect to PHYS 112, 122 and MACs 114, 114, respectively. In general, higher layers 316 and 326 may comprise suitable logic, circuitry, and/or code that may enable operability and/or functionality of the five highest functional layers for data packets, including support for time-sensitive protocols. Not shown in FIG. 3 are energy efficiency control policy entities within link partners 310, 320 that control the transitions between energy saving modes (e.g., LPI mode).

When the energy efficiency control policy entities transition link partners 310, 320 into an energy saving mode such as the LPI mode, communication that facilitates a time-sensitive protocol can be performed during the refresh signaling period between quiet states. Consider, for example, the communication of time synchronization information such as a time stamp. In this example, a time stamp is generated by time stamp (TS) unit 313 in link partner 310 and passed to PHY 312. PHY 312 would then encode the time stamp in the physical signaling that is transmitted during the refresh signaling time period between quiet states. In one embodiment, the time stamp information can replace the zeros that are subsequently scrambled to generate the refresh signal. As would be appreciated, the particular physical signaling mechanism for transmitting time stamp information during the refresh signaling time period would be implementation dependent.

At the receiving end, PHY 322 in link partner 320 would receive the physical signaling and would be configured to decode the physical signaling to recover the time stamp information. The time stamp information would be provided to TS unit 323 in link partner 320. The time stamp information can then be used to maintain time synchronization by link partner 320.

As has been described, the passage of time synchronization information during the refresh signaling time period of the LPI mode enables the use of energy efficient networking in a manner that is transparent to the operation of time-sensitive network protocols. Energy savings are therefore produced without producing a negative impact on time-sensitive network applications.

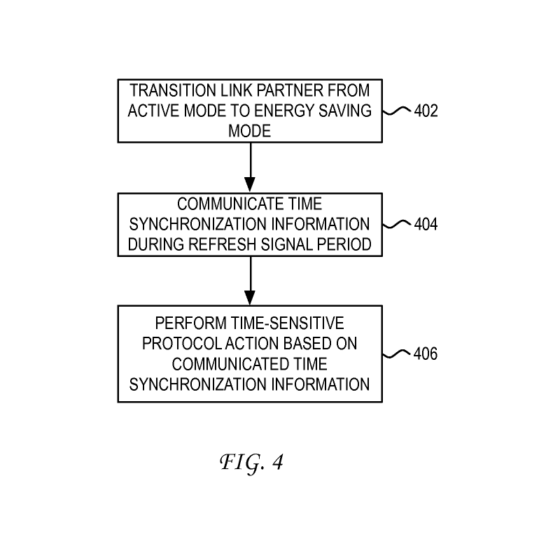

Reference is now made to FIG. 4, which illustrates a flowchart of an example process. As illustrated, the process begins at step 402 where a link partner transitions from an active mode to an energy saving mode. An energy efficiency control policy within the link partner can be configured to effect such a transition based on a monitoring of the utilization of the link. As would be appreciated, the particular mechanism by which the energy efficiency control policy effects a determination of a need for such a transition would be implementation dependent.

In one embodiment, the energy saving mode is an LPI mode. During the LPI mode, the link partner would enter a quiet state where no communication between the link partners would occur. Energy savings would therefore be produced. Refresh signaling time periods can be interspersed amongst the quiet state time periods to enable passage of refresh signals (e.g., scrambled zeros). At step 404, the signals sent during one or more refresh signal periods are modified such that time synchronization information is passed between the link partners. In one example, this time synchronization information is generated by a time stamp unit within the link partner.

The passage of time synchronization information during the refresh signaling time period ensures that the time-sensitive protocol is not interrupted when an energy efficiency control policy effects a transition by a link partner from an active mode to an energy saving mode. Ordinarily, the time-sensitive protocol would be interrupted during the energy saving mode because the time-sensitive protocol packets would not be passed during the energy saving mode. Here, it should be noted that if time-sensitive protocol packets are passed periodically, then the effectiveness of the energy efficiency control policy in producing energy savings would be compromised.

In the present disclosure, the passage of time synchronization information in a non-packet form during the refresh signaling time period serves to produce complementary benefits between energy efficiency networks and time-sensitive protocol applications This complementary benefits are realized at step 406, when the time-sensitive protocol performs actions that have been facilitated by the passage of time synchronization information during one or more refresh signaling time periods.

Another embodiment of the present disclosure can provide a machine and/or computer readable storage and/or medium, having stored thereon, a machine code and/or a computer program having at least one code section executable by a machine and/or a computer, thereby causing the machine and/or computer to perform the steps as described herein.

Those of skill in the relevant art would appreciate that the various illustrative blocks, modules, elements, components, and methods described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Those of skill in the relevant art can implement the described functionality in varying ways for each particular application. Various components and blocks may be arranged differently (e.g., arranged in a different order, or partitioned in a different way) all without departing from the scope of the subject technology.

These and other aspects of the present disclosure will become apparent to those skilled in the relevant art by a review of the preceding detailed disclosure. Although a number of salient features of the present disclosure have been described above, the principles in the present disclosure are capable of other embodiments and of being practiced and carried out in various ways that would be apparent to one of skill in the relevant art after reading the present disclosure, therefore the above disclosure should not be considered to be exclusive of these other embodiments. Also, it is to be understood that the phraseology and terminology employed herein are for the purposes of description and should not be regarded as limiting.

What is claimed is:

1. A method performed by a network device, comprising:
transitioning, by the network device, at least part of the network device from an active mode to a low power idle mode, the low power idle mode characterized by a plurality of quiet periods where no transmission by the network device occurs and by a plurality of refresh signaling periods that enable the network device to maintain synchronization with a link partner device; and
transmitting, during at least one of the refresh signaling periods, time synchronization information that enables the link partner device to perform an action associated with a time-sensitive network application upon transitioning of the link partner device from the low power idle mode to the active mode.

2. The method of claim 1, wherein the time synchronization information is a timestamp.

3. The method of claim 1, wherein the action is associated with the IEEE 1588 protocol.

4. The method of claim 1, wherein the action is associated with the 802.1AS protocol.

5. The method of claim 1, wherein the transmitting comprises transmitting time synchronization information in each of the plurality of refresh signaling periods.

6. The method of claim 1, further comprising transmitting master clock priority information during one of the refresh signaling periods.

7. A method performed by a network device, comprising:
transitioning, by the network device, at least part of the network device from an active mode to a low power idle mode, the low power idle mode characterized by a plurality of quiet periods where no transmission by the network device occurs and by a plurality of refresh signaling periods that enable the network device to maintain synchronization with a link partner device; and
receiving, during at least one of the refresh signaling periods, time synchronization information from the link partner device that enables the network device to perform an action associated with a time-sensitive network application upon transitioning from the low power idle mode to the active mode.

8. The method of claim 7, wherein the time synchronization information is a timestamp.

9. The method of claim 7, wherein the action is associated with the IEEE 1588 protocol.

10. The method of claim 7, wherein the action is associated with the 802.1AS protocol.

11. The method of claim 7, wherein the receiving comprises receiving time synchronization information in each of the plurality of refresh signaling periods.

12. The method of claim 7, further comprising receiving master clock priority information during one of the refresh signaling periods.

13. A network device, comprising:
a physical layer device that is configured to transition from an active mode to a low power idle mode, the low power idle mode characterized by a plurality of quiet periods where no transmission by the network device occurs and by a plurality of refresh signaling periods that enable the network device to maintain synchronization with a link partner device; and
a timestamp unit that is configured to receive time synchronization information that is received by the network device during at least one of the refresh signaling periods, the received time synchronization information enabling the timestamp unit to adjust a local clock of the network device in preparation for performing an action associated with a time-sensitive network application upon transitioning of the physical layer device from the low power idle mode to the active mode.

14. The network device of claim 13, wherein the time synchronization information is a timestamp.

15. The network device of claim 13, wherein the action is associated with the IEEE 1588 protocol.

16. The network device of claim 13, wherein the action is associated with the 802.1AS protocol.
